(19) United States
(12) Patent Application Publication
(10) Pub. No.: US 2026/0320083 A1
(43) Pub. Date: Oct. 15, 2026

(54) INFORMATION PROCESSING DEVICE, INFORMATION PROCESSING SYSTEM, INFORMATION PROCESSING METHOD, AND PROGRAM

(71) Applicant: Preferred Networks, Inc., Tokyo (JP)

(72) Inventors: Masashi SHIBATA, Tokyo (JP); Keita HIGUCHI, Tokyo (JP); Takuya INOUE, Tokyo (JP); Toshihiko YANASE, Tokyo (JP)

(21) Appl. No.: 19/467,162

(22) Filed: Feb. 2, 2026

Related U.S. Application Data
(63) Continuation of application No. PCT/JP2024/027023, filed on Jul. 29, 2024.

(30) Foreign Application Priority Data
Aug. 4, 2023 (JP) 2023-127594

(51) Int. Cl. G06F 16/332; G06F 3/04847

(52) U.S. Cl. CPC G06F 16/3326; G06F 3/04847

(57) ABSTRACT

An information processing device includes: at least one memory; and at least one processor configured to: generate a first prompt; acquire a first output result generated by a model in response to an input of the first prompt; acquire first feedback information for the first output result; generate a second prompt by using information acquired through execution of a predetermined algorithm based on the first feedback information; and acquire a second output result generated by the model in response to an input of the second prompt.

### CROSS-REFERENCE TO RELATED APPLICATIONS

This application is a continuation application of International Application No. PCT/JP2024/027023, filed on Jul. 29, 2024, and designated the U.S., which is based upon and claims priority to Japanese Patent Application No. 2023-127594, filed on Aug. 4, 2023, the entire contents of which are incorporated herein by reference.

### BACKGROUND OF THE INVENTION

### 1. Field of the Invention

The present disclosure relates to an information processing device, an information processing system, an information processing method, and a program.

### 2. Description of the Related Art

Language models recognize text, extract and classify information from data containing a large amount of text such as documents, and directly generate text. Such language models are used across a wide range of text-based domains, including search engines, document generation, free-form interaction, data parsing, knowledge provision, programming, and text style transformation. For example, when instruction text referred to as a prompt is entered, a language model generates target information in accordance with conditions specified by the prompt (see, for example, Japanese Patent Application Laid-Open Publication No. 2023-043129).

### SUMMARY OF THE INVENTION

An information processing device includes: at least one memory; and at least one processor configured to: generate a first prompt; acquire a first output result generated by a model in response to an input of the first prompt; acquire first feedback information for the first output result; generate a second prompt by using information acquired through execution of a predetermined algorithm based on the first feedback information; and acquire a second output result generated by the model in response to an input of the second prompt.

### BRIEF DESCRIPTION OF THE DRAWINGS

FIG. 1 is a configuration diagram of an example of an information processing system according to an embodiment;

FIG. 2 is an explanatory diagram of an example of a prompt according to an embodiment;

FIG. 3 is an illustrative view of an example of an application screen according to an embodiment;

FIG. 4 is a sequence diagram illustrating an example of a processing procedure of the information processing system according to an embodiment;

FIG. 5 is a sequence diagram illustrating the example of the processing procedure of the information processing system according to an embodiment;

FIG. 6 is an explanatory diagram of an example of a prompt according to an embodiment;

FIG. 7 is an example of code for implementing processing that measures a distance between vector representations in item text and uses the distance to select the next item;

FIG. 8A is an explanatory diagram of an example of an evaluation value entry form;

FIG. 8B is an explanatory diagram of an example of an evaluation value entry form;

FIG. 8C is an explanatory diagram of an example of an evaluation value entry form;

FIG. 9 is a block diagram illustrating an example of a hardware configuration of each device in the embodiments; and

FIG. 10 is an explanatory diagram of an example of a prompt template according to an embodiment.

### DESCRIPTION OF THE EMBODIMENTS

The present disclosure provides an information processing device configured to assist in generating a prompt to be input to a language model.

Hereinafter, embodiments of the present disclosure will be described with reference to the accompanying drawings. In this specification and the drawings, components having substantially the same functional configuration are denoted by the same reference signs, and redundant descriptions thereof will be omitted.

### System Configuration

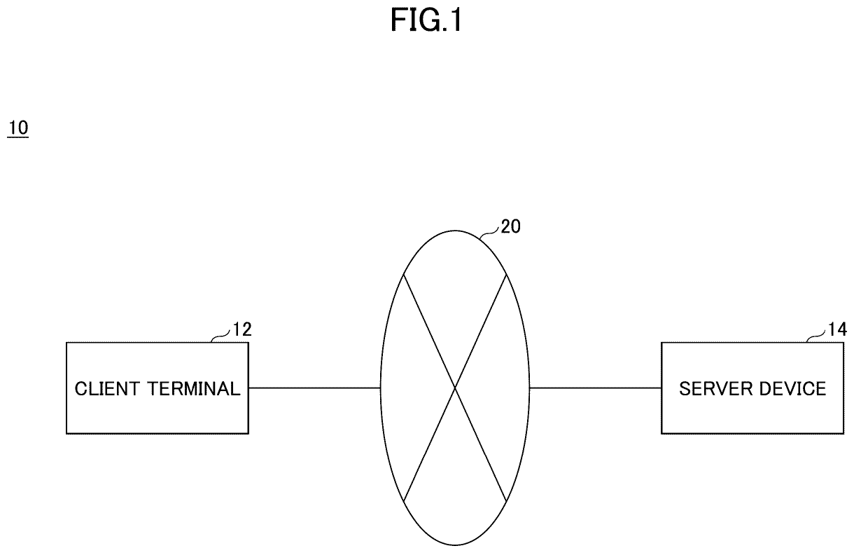

FIG. 1 is a configuration diagram of an example of an information processing system 10 according to the present embodiment. The information processing system 10 in FIG. 1 may include a client terminal 12 and a server device 14. The client terminal 12 and the server device 14 may be connected via a communication network 20, such as a local area network (LAN) or the Internet, so as to be capable of data communication.

The client terminal 12 may be an information processing device operated by a user, such as a personal computer (PC), a tablet terminal, or a smartphone. The client terminal 12 may execute an application program (hereinafter referred to as an app) according to the present embodiment and display an app screen. The client terminal 12 may be installed with a program configured to execute black-box optimization, which is an example of an optimization algorithm. Optuna (trademark) is an example of a black-box optimization tool.

The black-box optimization tool may repeatedly perform processing in which, in order to select (determine) one or more items to be tried in a next trial from among a plurality of items that can be specified in a prompt as options, one or more items that appear promising are selected based on a history of completed trials, and a next trial is executed with a prompt including the selected one or more items. The prompt is an example of instruction text for the language model.

The server device 14 may be provided with a language model such as a large language model (LLM). The server device 14 may input a prompt received from the client terminal 12 to the language model, obtain an output result in accordance with a condition specified by the prompt, and transmit the output result to the client terminal 12. The server device 14 may be an information processing device such as a PC or a workstation.

Note that the information processing system 10 in FIG. 1 is merely an example. The information processing system 10 may take various system configuration forms depending on its use or purpose. For example, the information processing system 10 may be configured with one or more information processing devices. One information processing device may be implemented as a system including a plurality of devices. The information processing system 10 may have the server device 14, instead of the client terminal 12, execute the black-box optimization tool that is executed on the client terminal 12. The information processing system 10 may include a server device other than the server device 14 that executes the black-box optimization tool instead of the client terminal 12. The server device 14 of the information processing system 10 may be implemented on a cloud computing service.

### Example of Prompt

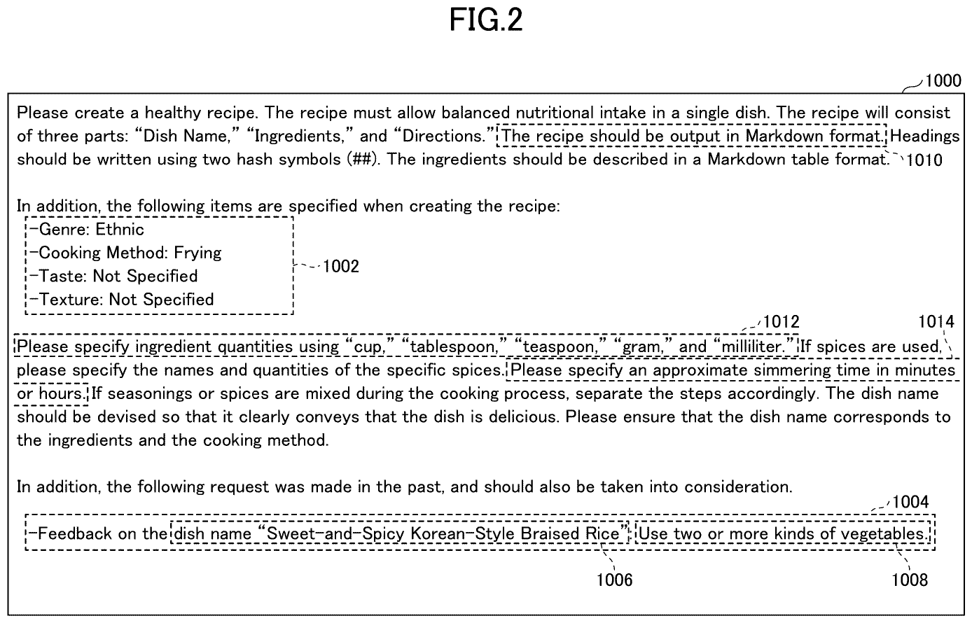

FIG. 2 is an explanatory diagram of an example of a prompt 1000 according to the present embodiment. The prompt 1000 in FIG. 2 illustrates a hypothetical example in which a language model generates a cooking recipe.

A portion 1002 of the prompt 1000 specifies, as conditions, one or more items determined by the black-box optimization tool. The portion 1002 of the prompt 1000 specifies, as conditions, one or more items for a genre, a cooking method, a taste, and a texture for the next recipe to be generated. For example, the portion 1002 of the prompt 1000 specifies the item “Ethnic” as a genre condition for the recipe to be generated, and specifies the item “Frying” as a cooking-method condition for the recipe to be generated.

A portion 1004 of the prompt 1000 corresponds to a constraint condition that is specified based on user feedback information for recipes generated in the past by the language model. The portion 1004 of the prompt 1000 is appended each time the user enters free-form feedback information in natural language for recipes generated in the past by the language model.

A portion 1006 of the prompt 1000 includes a recipe name, “Sweet-and-spicy Korean-style braised rice,” which is part of a recipe generated in the past by the language model. The recipe name “sweet-and-spicy Korean-style braised rice” may be entered into the portion 1006 of the prompt 1000 by the user by copying and pasting the recipe name from a recipe generated in the past. A portion 1008 of the prompt 1000 specifies, as a condition, user feedback information in natural language for the recipe corresponding to the recipe name in the portion 1006 of the prompt 1000.

For example, free-form text written by the user in a portion 1008 of the prompt 1000, such as “Use two or more kinds of vegetables,” becomes a constraint condition for the next recipe to be generated. Other portions of the prompt 1000 besides portions 1002, 1006, and 1008 may be predetermined.

As illustrated in a portion 1010 of the prompt 1000 in FIG. 2, the prompt 1000 may specify, as an output format, a markup language such as “Markdown,” “JSON,” “YAML,” or “XML.” The prompt 1000 in which a markup language is specified as the output format can be combined with a viewer corresponding to the markup language, such as a Markdown viewer, to convert output results generated by the language model into a user-friendly form.

In addition, when a markup language is specified as the output format in the prompt 1000, partial information such as a dish name can be retrieved. Therefore, the app according to the present embodiment facilitates output of a list of dish names, such as a list 1102 of a plurality of recipes described later.
As illustrated in a portion 1004 of the prompt 1000 in FIG. 2, to specify a recipe generated in the past by the language model, instead of describing the entire recipe in the prompt 1000, summary information such as a “dish name” is retrieved from the recipes generated in the past and described in the prompt 1000. This can suppress growth in the number of characters of the prompt 1000. For example, the summary information may be retrieved by requesting the server device 14 to provide a summary of a recipe generated in the past, or may be automatically retrieved by describing the prompt 1000 such that the dish name of a recipe is written at a predetermined position, such as the first line in a recipe generated by the language model.

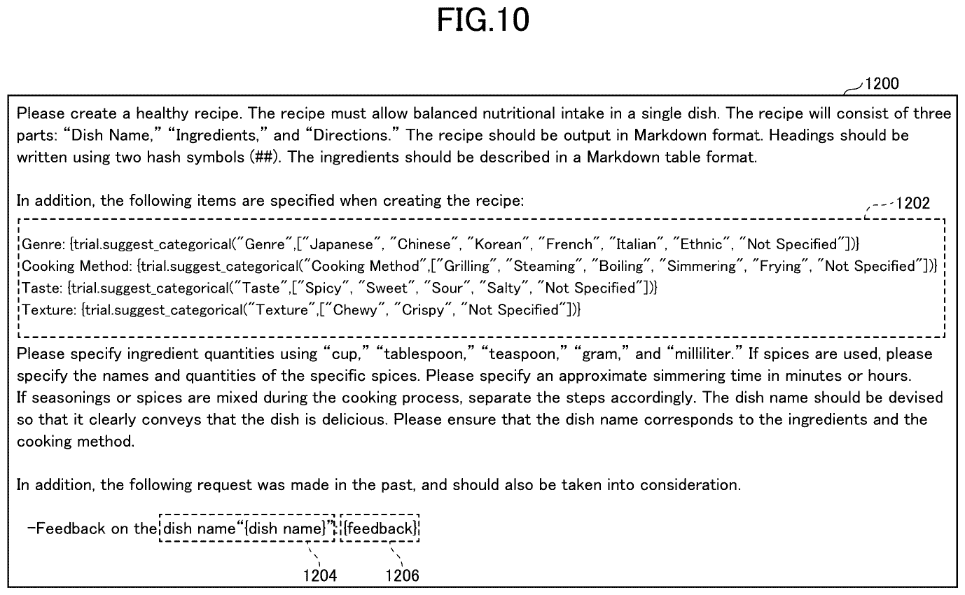

In the present embodiment, in order to specify one or more items from multiple selectable items by using the black-box optimization tool, candidate items 1202 may be listed in a prompt template 1200, for example, as illustrated in FIG. 10. The prompt template 1200 is used to create the prompt 1000. FIG. 10 is an explanatory diagram of an example of a prompt template according to the present embodiment. A portion 1204 of the prompt template 1200 is a field in which a dish name, which is partial information of a recipe generated by the language model, is entered. A portion 1206 of the prompt template 1200 is a field in which user feedback information is written in natural language for the recipe corresponding to the dish name entered into the portion 1204.

For example, the prompt template used to generate the prompt 1000 may include candidate items listed as illustrated below. In the following example, “Japanese,” “Chinese,” “Korean,” “French,” “Italian,” “Ethnic,” and “Not Specified” are listed as candidate items for “Genre”; “Grilling,” “Steaming,” “Boiling,” “Simmering,” “Frying,” and “Not Specified” are listed as candidate items for “Cooking Method”; “Spicy,” “Sweet,” “Sour,” “Salty,” and “Not Specified” are listed as candidate items for “Taste”; and “Chewy,” “Crispy,” and “Not Specified” are listed as candidate items for “Texture.” “In addition, the following items are specified when creating the recipe:
Genre: {trial.suggest_categorical(“Genre”, [“Japanese”, “Chinese”, “Korean”, “French”, “Italian”, “Ethnic”, “Not Specified”])}
Cooking Method {trial.suggest_categorical(“Cooking Method”, [“Grilling”, “Steaming”, “Boiling”, “Simmering”, “Frying”, “Not Specified”])}
Taste: {trial.suggest_categorical(“Taste”, [“Spicy”, “Sweet”, “Sour”, “Salty”, “Not Specified”])}
Texture: {trial.suggest_categorical(“Texture”, [“Chewy”, “Crispy”, “Not Specified”])}

As illustrated in a portion 1012 of the prompt 1000 in FIG. 2, the prompt 1000 may specify not only the output format but also units for ingredients so as to standardize the format of the output result generated by the language model.

For example, in the prompt 1000 in FIG. 2, the ingredient quantities described in the cooking recipe generated by the language model are specified using “cup,” “tablespoon,” “teaspoon,” “gram,” and “milliliter.”

As illustrated in a portion 1014 of the prompt 1000 in FIG. 2, the prompt 1000 may specify a unit of time so as to standardize the format of the output result generated by the language model. The prompt 1000 in FIG. 2 is merely an example and may include information (e.g., image and audio) other than text.

### Example of Recipe

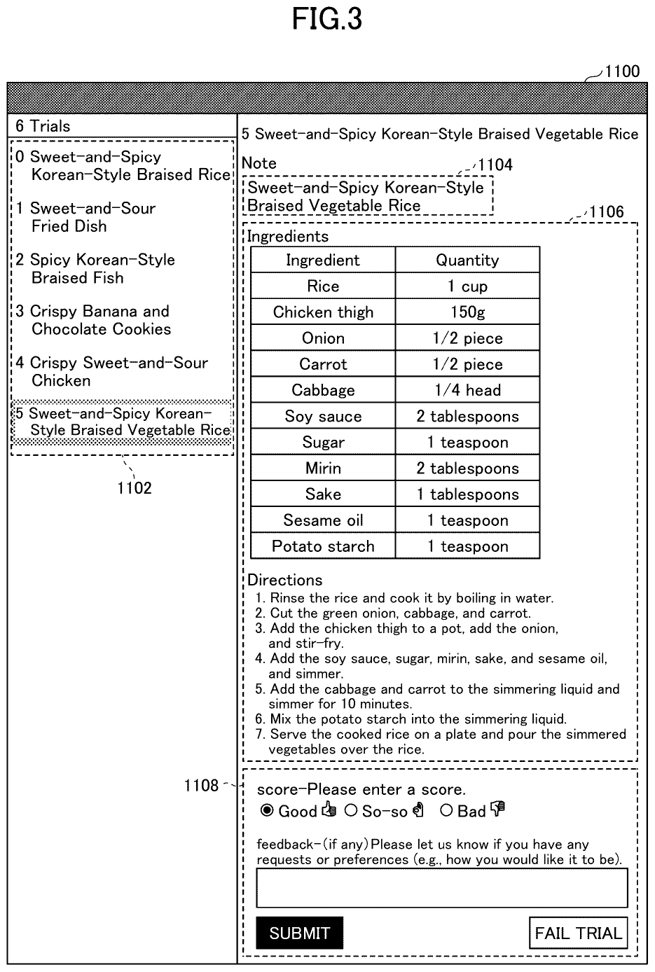

A recipe, which is a hypothetical example of an output result generated by the language model in response to, for example, an input of the prompt 1000 in FIG. 2, may be displayed on the app screen 1100 illustrated in FIG. 3. FIG. 3 is an illustrative view of an example of the app screen 1100 according to the present embodiment.

The app screen 1100 in FIG. 3 may display a list 1102 of a plurality of recipes generated in the past by the language model. The app screen 1100 in FIG. 3 displays a recipe name 1104 and recipe details 1106 of a recipe selected by the user from the list 1102. The recipe name 1104 and the recipe details 1106 on the app screen 1100 in FIG. 3 are examples of output results generated in response to an input of the prompt 1000 to the language model.

The app screen 1100 in FIG. 3 displays a feedback information entry field 1108 for receiving an entry of user feedback information for the recipe name 1104 and the recipe details 1106.

The user can enter, into the feedback information entry field 1108 on the app screen 1100, information indicating an evaluation value, which is an example of feedback information for the recipe displayed on the app screen 1100, and free-form text, which is an example of information in natural language. The information indicating the evaluation value may be “Good,” “So-so,” or “Bad” associated with the evaluation value, as illustrated in the feedback information entry field 1108 in FIG. 3, for example. The feedback information may be acquired by recognizing the voice of the user. The feedback information may be acquired by the user selecting one or more desired recipes from the list 1102 of the plurality of recipes generated in the past by the language model, or selecting one or more undesired recipes from the list 1102 of the plurality of recipes. The details of the feedback information entry field 1108 on the app screen 1100 will be described later.

### Processing Procedure

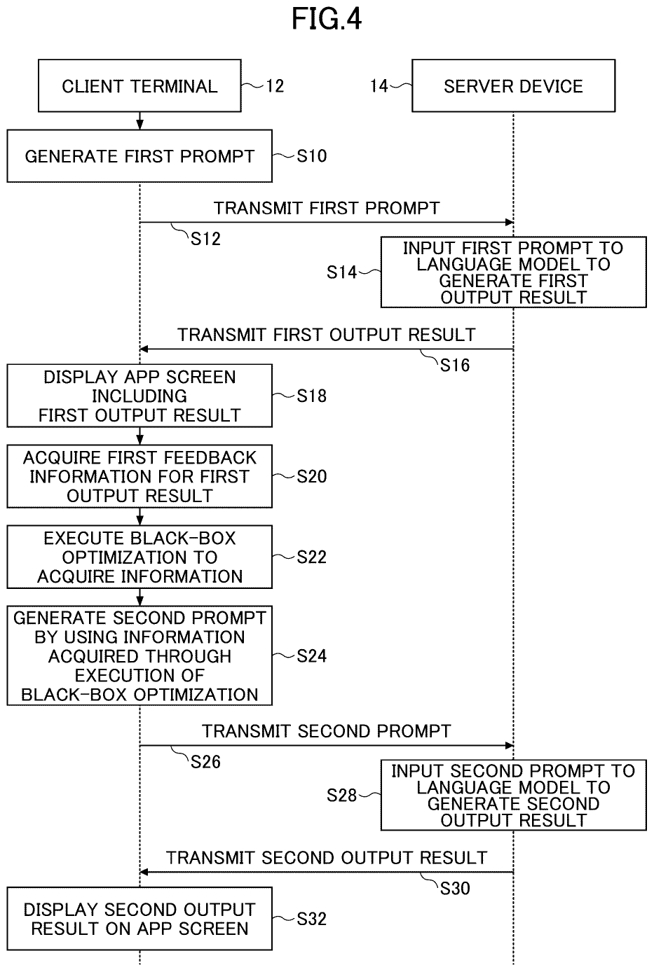

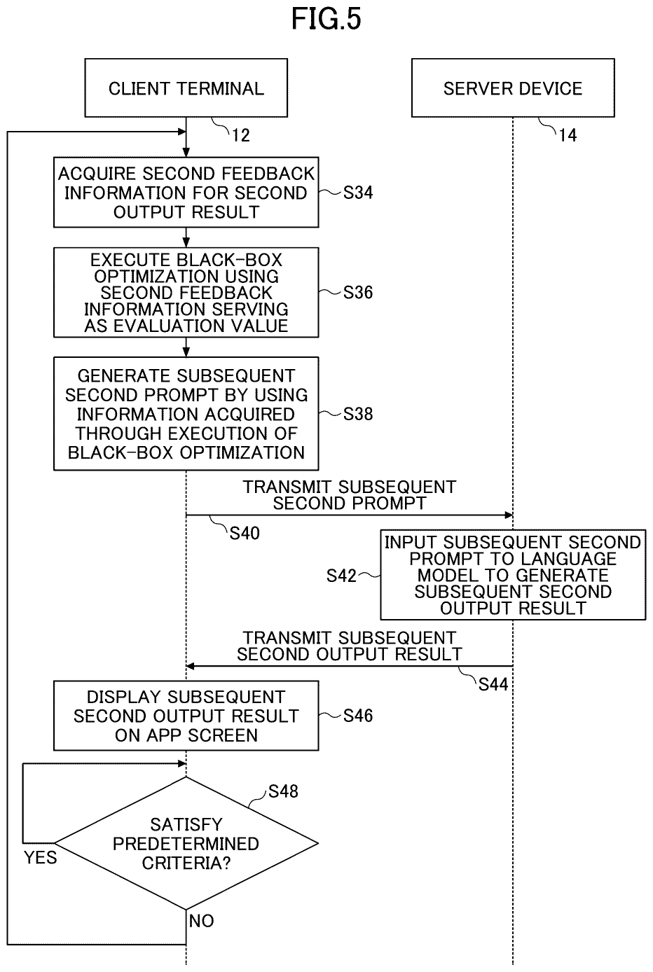

The information processing system 10 according to the present embodiment is configured to assist in generating a prompt to be input to a language model, for example, in a procedure illustrated in FIGS. 4 and 5. FIGS. 4 and 5 are sequence diagrams illustrating an example of a processing procedure of the information processing system 10 according to the present embodiment.

In Step S10, the client terminal 12 generates a first prompt based on a prompt template, which is an example of a predetermined template. Note that the first prompt may be an initial prompt. For example, in the case of the prompt 1000 in FIG. 2, the client terminal 12 may randomly select an item for the portion 1002 of the prompt 1000.

Instead of randomly selecting an item for the portion 1002 of the prompt 1000, the client terminal 12 may select an item in accordance with a preset setting. The user may customize whether to select an item randomly or in accordance with the preset setting. In the case of the initial prompt 1000, the portion 1004 may be empty (blank). The client terminal 12 generates the first prompt based on the selection result of an item for the portion 1002 of the prompt 1000 and on the prompt template.

In Step S12, the client terminal 12 transmits the first prompt generated in Step S10 to the server device 14. In Step S14, the server device 14 receives the first prompt. The server device 14 inputs the received first prompt to the language model to generate a first output result. For example, the server device 14 may input the first prompt to ChatGPT (trademark) which is an example of a language model, to generate the first output result. The first output result is, for example, a cooking recipe generated by the language model in accordance with a condition specified by the first prompt. In Step S16, the server device 14 transmits the first output result generated in Step S14 to the client terminal 12.

In Step S18, the client terminal 12 displays the first output result received from the server device 14 on the app screen. For example, the client terminal 12 displays a recipe, which is an example of the first output result received from the server device 14, on the app screen 1100 in FIG. 3.

In Step S20, the user evaluates the first output result displayed on the app screen, and inputs first feedback information for the first output result to the client terminal 12.

For example, the user evaluates the recipe displayed on the app screen 1100 in FIG. 3, and inputs the evaluation of the recipe as the user feedback information to the feedback information entry field 1108.

The client terminal 12 acquires, as the first feedback information, the user's evaluation of the first output result displayed on the app screen. For example, in the case of the app screen 1100 in FIG. 3, the client terminal 12 can acquire, as the feedback information for the recipe, information indicating the evaluation value by the user for the recipe and the free-form text, which have been entered into the feedback information entry field 1108.

The evaluation information by the user for the first output result displayed on the app screen may be specified and received through manipulation of a radio button associated with the evaluation value, or through manipulation of a slider associated with the evaluation value. The user may specify the evaluation information via a user interface (UI) for comparative evaluation, which displays a plurality of first output results simultaneously and allows the user to select the first output result with the higher evaluation. In the UI for comparative evaluation, the evaluation value of the selected first output result becomes higher than the evaluation value of the first output result that is not selected. In the UI for comparative evaluation, a value indicating the degree to which one output result is superior to another output result may be entered via a slider or the like. In the UI for comparative evaluation, the output results generated by the language model may be processed by a program in order to perform comparative evaluation.

The user may specify the evaluation information via a UI for ranking evaluation, which displays a plurality of first output results simultaneously and allows the user to rank the first output results. The evaluation information may be specified with an evaluation value that can be computed by a computer, instead of being specified by the user. In the case of a recipe, an evaluation value that can be computed by a computer may be, for example, the calorie content of the ingredients. Further, the evaluation information may be specified with a combination of an evaluation value specified by the user and an evaluation value computed by a computer.

In Step S22, the client terminal 12 executes black-box optimization using the first feedback information as the evaluation value to acquire information for use in generating a second prompt. The client terminal 12 determines an item to be specified as a condition in a next prompt, based on a history in which one or more items determined through past executions of black-box optimization are associated with evaluation values of the first output results generated by the language model in response to an input of a prompt including those items that have been specified as conditions.

The optimization algorithm based on the feedback information may employ, for example, black-box optimization or gray-box optimization. The feedback information may be acquired from the user or may be automatically generated by the client terminal 12. The black-box optimization and the gray-box optimization are examples of the optimization algorithms based on feedback information. Examples of the black-box optimization include multi-objective optimization, Bayesian optimization, and evolutionary computation. Examples of the gray-box optimization include multi-fidelity optimization. Specifically, the black-box optimization may employ a tree-structured Parzen estimator (TPE), Gaussian process Bayesian optimization (GP-BO), covariance matrix adaptation evolution strategy (CMA-ES), non-dominated sorting genetic algorithm II (NSGA-II), or the like. In the black-box optimization, items with high evaluation values and items that have not been tried may be selected in a proper balance. The black-box optimization may be used to adjust a temperature value, which is an example of a parameter used during execution of a language model. The temperature is a parameter for adjusting randomness in an output result of the language model.

Note that the client terminal 12 may use part of the history in which one or more items determined through past executions of black-box optimization are associated with evaluation values of the first output results generated by the language model in response to an input of a prompt including those items that have been specified as conditions. For example, the user may specify the filtering of the history to be used.

The client terminal 12 may use part of the recipe history by filtering, such as a history of recipes that use two or more kinds of vegetables or a history of Italian recipes. By filtering, the client terminal 12 can cope with cases where the “black box” of the black-box optimization differs. For example, to create recipes that use two or more kinds of vegetables, a recipe that does not use any vegetables and its evaluation value may disadvantageously introduce noise to the black-box optimization algorithm. In that case, by limiting (filtering) the history to recipes that use two or more kinds of vegetables, it is possible to eliminate noise and apply the black-box optimization algorithm as expected.

To filter the history, the client terminal 12 may request the user to reassign the evaluation value. For example, the client terminal 12 may display a UI for reassigning the evaluation value on the app screen. The user may specify the filtering of the history.

A language model may specify the filtering of the history by using the user feedback information in natural language as a trigger. For example, in a case where the first output result is a recipe, the client terminal 12 may input, for each past recipe, a prompt including a question such as “Does this recipe use two or more kinds of vegetables?” to a language model such as ChatGPT, and obtain a Yes/No answer.

In Step S24, the client terminal 12 generates the second prompt by using the information acquired through the execution of the black-box optimization in Step S22. If the feedback information in Step S20 includes free-form text written by the user in natural language, the client terminal 12 further uses the free-form text to create the second prompt.

For example, in the case of the prompt 1000 in FIG. 2, the client terminal 12 specifies the item determined through the execution of the black-box optimization in Step S22 as the item for the portion 1002 of the prompt 1000. In the case of the app screen 1100 in FIG. 3, the client terminal 12 specifies, as a constraint condition for the portion 1008 of the prompt 1000 in FIG. 2, the free-form text that is an example of information on natural language entered into the feedback information entry field 1108.

In Step S26, the client terminal 12 transmits the second prompt generated in Step S24 to the server device 14. In Step S28, the server device 14 receives the second prompt. The server device 14 inputs the received second prompt to the language model to generate a second output result. For example, the server device 14 may input the second prompt to ChatGPT (trademark), which is an example of a language model, to generate the second output result. The second output result is, for example, a cooking recipe generated by the language model in accordance with a condition specified by the second prompt. In Step S30, the server device 14 transmits the second output result generated in Step S28 to the client terminal 12.

In Step S32, the client terminal 12 displays the second output result received from the server device 14 on the app screen. For example, the client terminal 12 displays a recipe, which is an example of the second output result received from the server device 14, on the app screen.

In Step S34, the user evaluates the second output result displayed on the app screen, and enters second feedback information for the second output result to the client terminal 12. For example, the user evaluates the recipe displayed in Step S32, and enters the evaluation of the recipe as the user feedback information in the feedback information entry field.

The client terminal 12 acquires, as the second feedback information, the user's evaluation of the second output result displayed in Step S32. For example, in the case of the app screen 1100 in FIG. 3, the client terminal 12 can acquire, as the feedback information for the recipe, information indicating the evaluation value by the user for the recipe and the free-form text, which have been entered into the feedback information entry field 1108.

In Step S36, the client terminal 12 executes the black-box optimization by using the second feedback information as the evaluation value. In Step S38, the client terminal 12 generates a subsequent second prompt by using the information acquired through the execution of the black-box optimization in Step S36.

If the feedback information in Step S34 includes free-form text written by the user in natural language, the client terminal 12 further uses the free-form text to create the subsequent second prompt.

In Step S40, the client terminal 12 transmits the subsequent second prompt generated in Step S38 to the server device 14. In Step S42, the server device 14 receives the subsequent second prompt. The server device 14 inputs the received next second prompt to the language model to generate a subsequent second output result.

For example, the server device 14 may input the subsequent second prompt to ChatGPT (trademark) which is an example of a language model, to generate the subsequent second output result. The subsequent second output result is, for example, a cooking recipe generated by the language model in accordance with a condition specified by the subsequent second prompt. In Step S44, the server device 14 transmits the subsequent second output result generated in Step S42 to the client terminal 12.

In Step S46, the client terminal 12 displays the subsequent second output result received from the server device 14 on the app screen. For example, the client terminal 12 displays a recipe, which is an example of the subsequent second output result received from the server device 14, on the app screen.

In Step S48, the client terminal 12 determines whether or not a predetermined criterion for stopping the repeated execution of the processing in Steps S34 to S48 is satisfied. If the predetermined criterion is not satisfied, the client terminal 12 repeats the processing in Steps S34 to S48. If the predetermined criterion is satisfied, the client terminal 12 stops the processing in Steps S34 to S48 until the predetermined criterion is not satisfied. For example, the client terminal 12 may determine whether or not the predetermined criterion is satisfied each time the output result is received from the server device 14.

For example, in the example of the app screen 1100 in FIG. 3, the processing in Steps S34 to S48 may be repeated until a predetermined criterion in which five output results for which the user has not fed back the evaluation are included in the list 1102 is satisfied.

The client terminal 12 that is stopping the processing in Steps S34 to S48 may determine that the predetermined criterion is no longer satisfied based on the user evaluating the output results included in the list 1102 and providing feedback, and may resume the processing in Steps S34 to S48. The predetermined criterion may be that an upper limit is reached in the number of output results. The predetermined criterion may be convergence of the output results toward a user's preference. The client terminal 12 may check the load status of the server device 14 and stop the processing in Steps S34 to S48 if the server device 14 is congested and lacks sufficient computation capacity.

The black-box optimization illustrated in the sequence diagrams in FIGS. 4 and 5 may be executed so as to try all combinations of items. In addition, the black-box optimization illustrated in the sequence diagrams in FIGS. 4 and 5 may be executed by, for example, randomly selecting an item for an initial predetermined number of times (e.g., five times), and, after that predetermined number of times, estimating and selecting a promising item based on the past history.

The execution of the black-box optimization illustrated in the sequence diagrams in FIGS. 4 and 5 may be omitted when the feedback information includes free-form text written by the user in natural language, in which case the item specified by the previous prompt may be copied instead. In this case, the next prompt has content in which the free-form text written by the user in natural language is specified as a condition in, for example, the portion 1008 of the prompt 1000 in FIG. 2, while an item specified as a condition in the portion 1002 of the prompt 1000 remains unchanged.

### Black-Box Optimization

The search space of items determined through the execution of the black-box optimization changes depending on whether the feedback information includes free-form text written by the user in natural language, or on the content described by the user in the feedback information. Therefore, in the black-box optimization according to the present embodiment, when the past search results change, or when the content described by the user in the feedback information has an overall influence on the feedback information, the item search may be performed again.

“When the content described by the user in the feedback information has an overall influence on the feedback information” refers, for example, to a case where no dish name is specified and only a condition such as “two or more kinds of vegetables” is specified. In a case where no dish name is specified and only a condition such as “two or more kinds of vegetables” is specified, search results using two or more kinds of vegetables are extracted from the past history, and the item search is performed again based on the past history.

The execution of the black-box optimization according to the present embodiment may be performed so as to continuously search for items. By continuously searching for items, the information processing system 10 according to the present embodiment can generate a plurality of prompts and input the plurality of prompts to the language model to acquire a plurality of corresponding output results (e.g., recipes).

In general, the processing of generating a prompt and the processing of inputting the generated prompt to a language model to obtain an output result are time-consuming. Accordingly, when the process of generating one prompt, inputting the generated prompt to the language model to obtain one output result, and having the user evaluate that output result is repeated, the user's waiting time increases.

Therefore, in the present embodiment, a plurality of prompts may be generated in advance, and the plurality of generated prompts may be input to the language model to obtain a plurality of corresponding output results. By allowing the user to consecutively evaluate the plurality of output results at once, the user experience (UX) can be improved.

Moreover, in the black-box optimization, closeness in concept may be used in determining an item. For example, the closeness in concept may be determined by using the similarity of vector representations (embeddings) of the texts of candidate items in an LLM. The similarity of the vector representations of the texts of candidate items can be computed by existing techniques and obtained in the form of vectors.

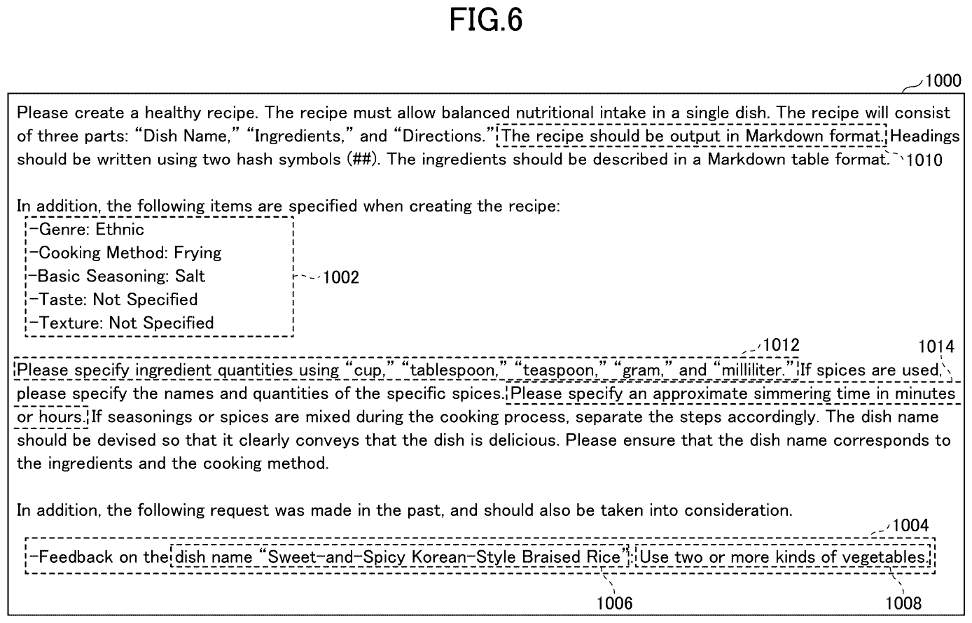

FIG. 6 is an explanatory diagram of an example of a prompt 1000 according to the present embodiment. Note that the prompt in FIG. 6 is the same as the prompt 1000 in FIG. 2 except for a portion 1002. The portion 1002 of the prompt 1000 corresponds to the portion 1002 in FIG. 2, with an additional condition specifying the basic seasoning item of the recipe to be generated next. For example, in the portion 1002 of the prompt 1000 in FIG. 6, the item “Ethnic” is specified as a condition for the genre of the recipe to be generated, the item “Frying” is specified as a condition for the cooking method of the recipe to be generated, and the item “Salt” is specified as a condition for the basic seasoning of the recipe to be generated.

The candidate items for the basic seasoning may be listed as including, for example, soy sauce, salt, miso, shio koji, doubanjiang, consommé, semi-thick Worcestershire sauce, ketchup, sugar, and the like. In addition to the candidate items for the basic seasoning, this can also be applied to the candidate items for the vegetable and the protein.

The candidate items for the vegetable may be listed as including, for example, cabbage, onion, potato, eggplant, green pepper, cucumber, tomato, and the like. The candidate items for the protein may be listed as including, for example, beef, pork, chicken, salmon, mackerel, tuna, shrimp, crab, and the like.

For example, in the case of the prompt in FIG. 6, if the evaluation value of a recipe generated when the basic seasoning item “salt” is selected in the prompt is high, an item such as “soy sauce,” whose vector representation in the text is close to that of “salt,” may be preferentially selected. Among the items with a small number of trials, an item that is similar to an item having a high evaluation value in the past history may be selected as the next item. The similarity of items may be determined using distances between vector representations in the text, or the like.

For example, in the case of a prompt for generating a cooking recipe, the types of ingredients and seasonings are finite, and the distances between vector representations in the text can be expected to be meaningful.

For example, when one item of “basic seasoning” in the portion 1002 of the prompt 1000 in FIG. 6 is selected, there are likely to be many recipes in which “salt” is used in place of “soy sauce.” On the other hand, there are likely to be few recipes in which “sugar” is used in place of “soy sauce.”

In this manner, by using a relationship known in advance, such as “soy sauce” being close to “salt” and far from “sugar,” the black-box optimization according to the present embodiment may select “salt,” rather than “sugar,” as the next item following “soy sauce.”

For example, numerical vectors such as the following may be assigned to the candidate items. The cosine similarity can determine whether the items are similar or not. By using the internal representation of the language model as numerical vectors, it is possible to determine whether items are similar or not.
Soy Sauce: [0.8, 0.8]
Salt: [0.7, 0.8]
Sugar: [−0.5, −0.5]

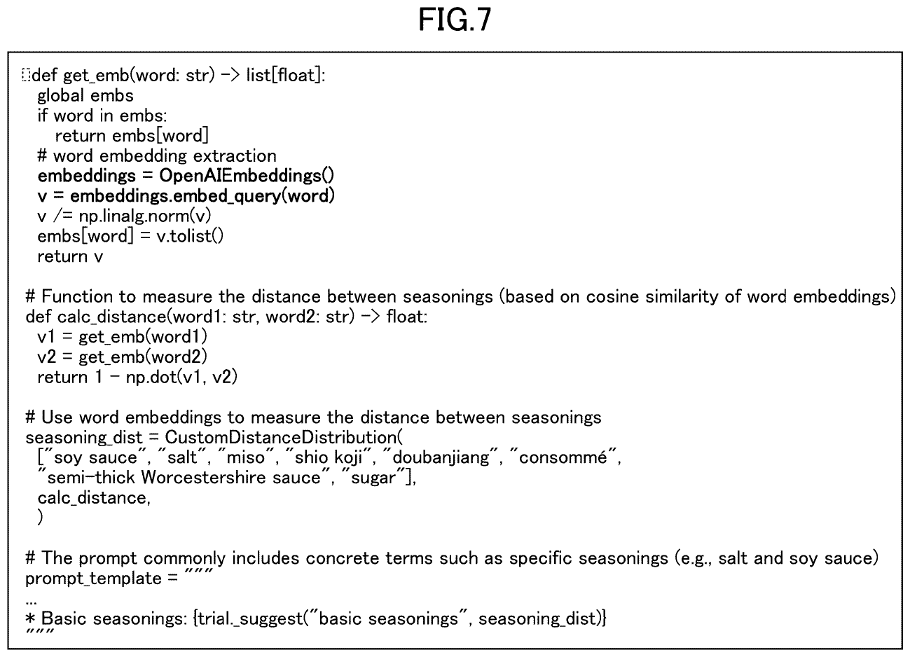

FIG. 7 is an example of code for implementing processing that measures a distance between vector representations in item text and uses the distance to select the next item. According to the code in FIG. 7, it is possible to measure the distance between the basic seasoning items and use the distance between the basic seasoning items to select the next item in the black-box optimization.

In the information processing system 10 according to the present embodiment, the information acquired through the execution of the black-box optimization can vary depending on the seed, even when the parameters are identical. In this case, the client terminal 12 may sample a plurality of parameters and generate a plurality of corresponding items based on the parameters. For example, the client terminal 12 may sample n parameters and generate a corresponding item for each parameter.

The user generates a plurality of prompts using the generated items, and evaluates the output results generated from the plurality of respective prompts, for example, by voting. The voting may be performed by ranking or by scoring (including negative scores). The client terminal 12 may determine an evaluation value for the parameter based on the user's voting results (e.g., the number of votes cast).

### Ensuring Consistency of User Evaluation Information

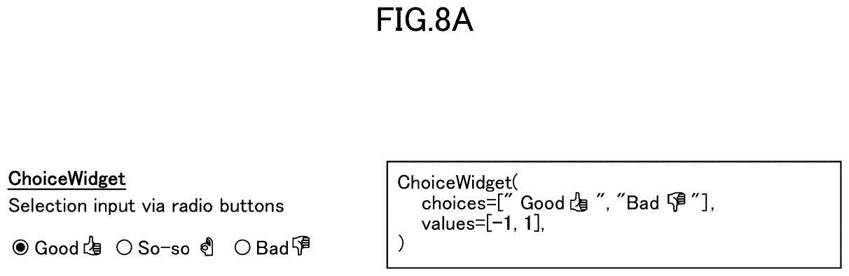

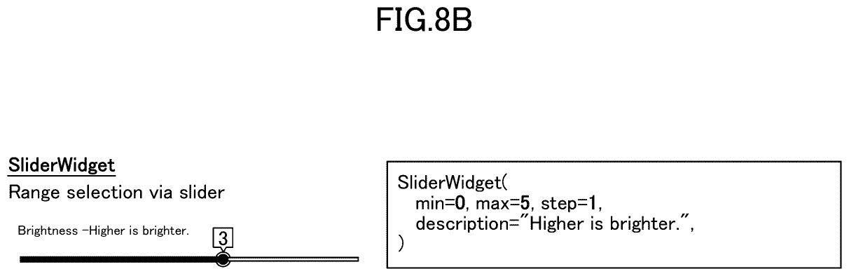

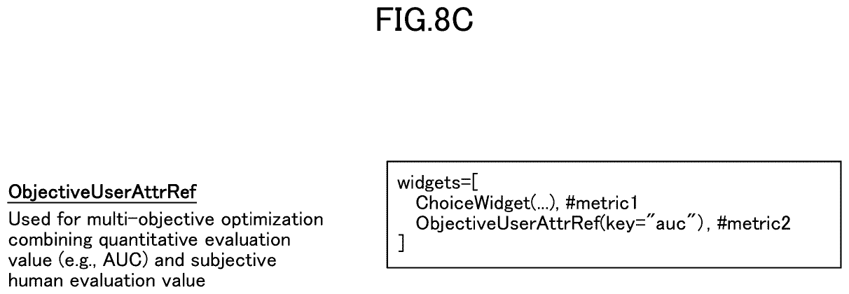

The user can specify an evaluation value for the output result displayed on the app screen, for example, by using various evaluation value entry forms illustrated in FIGS. 8A to 8C. FIGS. 8A to 8C are explanatory diagrams of examples of an evaluation value entry form.

For example, FIG. 8A is an example of an evaluation value entry form that receives an entry of an evaluation value from the user via operation of a radio button associated with the evaluation value. FIG. 8B is an example of an evaluation value entry form that receives an entry of an evaluation value (e.g., 1 to 5) from the user via operation of a slider associated with the evaluation value. FIG. 8C is an example of an evaluation value entry form that receives entries of evaluation values, combining a quantitative evaluation value (e.g., area under the curve (AUC)) and a subjective human evaluation value, for multi-objective optimization. Note that the user (e.g., a programmer or a general user) may select any one of the evaluation value entry forms illustrated in FIG. 8A to FIG. 8C for use.

The user may specify the evaluation value of the output result displayed on the app screen via a UI for comparative evaluation, which displays two output results simultaneously and allows the user to select the output result with the higher evaluation. The user may specify the evaluation value of the output result displayed on the app screen via the UI for comparative evaluation, which displays the past output result with the highest evaluation value and the current output result simultaneously and allows the user to select the output result with the higher evaluation. The user may specify the evaluation value of the output result displayed on the app screen via the UI for comparative evaluation, which displays the previous output result and the current output result simultaneously and allows the user to select the output result with the higher evaluation.

The user may specify the evaluation value of the output result displayed on the app screen via a UI for comparative evaluation, which displays a list of the output results the user has evaluated and allows the user to select the output result with the higher evaluation.

### Application Examples

In the present embodiment, a cooking recipe has been described as an example of an output result generated by a language model in response to an input of a prompt. However, the information processing system 10 according to the present embodiment may be used for other applications such as image generation, code review, substance generation, and finance. The image generation may be generation of a character such as an animated character. The substance generation may be generation of a substance from a material.

The code review may select items such as tests, data structures, and documents for the part of interest by using black-box optimization. Characteristics such as consistency, maintainability, or errors may be provided as item variations. A context (code difference) item may be provided as an item variation. The finance application may be the creation of individual stock investment strategies.

In addition, although a cooking recipe is illustrated as an example of a recipe in the present embodiment, the present embodiment can also be applied to recipes for dieting, recipes for health promotion, recipes that satisfy predetermined conditions, and the like. The recipe generated by the information processing system 10 of the present embodiment may be used as input to another recommendation system, such as a recipe recommendation system. For example, even in a recommendation system that requires precise inputs such as a genre of dish or nutritional conditions, information to be input to the recommendation system can be easily generated by the user entering feedback information for a recipe generated by the information processing system 10 according to the present embodiment. Therefore, the recommendation system can improve the UX of users without specialized expertise.

### Hardware Configuration

Some or all of the devices (the client terminal 12 and the server device 14) in the above-described embodiments may be implemented by hardware, or may be implemented by information processing of software (program) executed by a central processing unit (CPU), a graphics processing unit (GPU), or the like. In a case of implementing the devices by information processing of software, the software that implements at least some of the functions of the devices in the above-described embodiments may be stored in a non-transitory storage medium (non-transitory computer readable medium) such as a compact disc-read only memory (CD-ROM) or a universal serial bus (USB) memory and read by a computer to execute the information processing of the software. The software may also be downloaded via a communication network. Furthermore, all or part of the processing of the software may be implemented in a circuit such as an application specific integrated circuit (ASIC) or a field programmable gate array (FPGA) to execute information processing of the software by hardware.

A storage medium that stores the software may be a removable medium such as an optical disk, or a fixed storage medium such as a hard disk or a memory. The storage medium may also be provided inside the computer (a main storage device, an auxiliary storage device, or the like), or may be provided outside the computer.

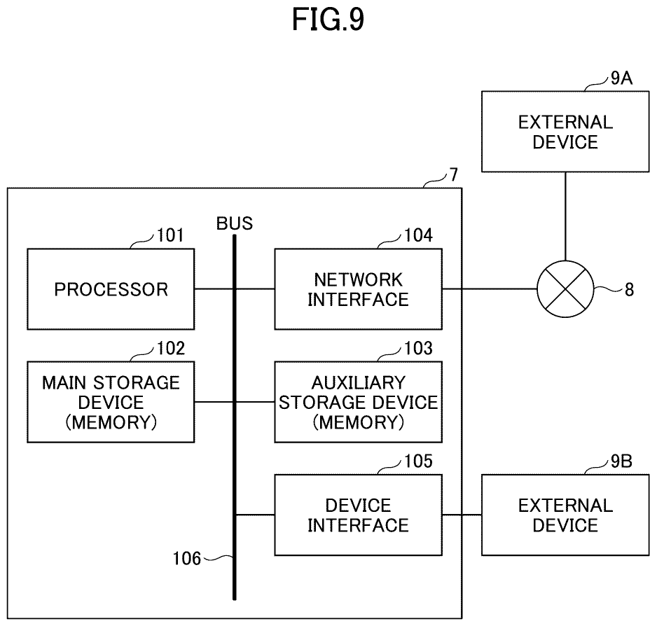

FIG. 9 is a block diagram illustrating an example of a hardware configuration of each device (the client terminal 12 and the server device 14) according to the above-described embodiments. For example, each device may be implemented as a computer 7 including a processor 101, a main storage device 102 (memory), an auxiliary storage device 103 (memory), a network interface 104, and a device interface 105, which are connected via a bus 106.

The computer 7 in FIG. 9 includes one or more of each component. Although one computer 7 is illustrated in FIG. 9, the software may be installed on a plurality of computers, and the plurality of computers may each execute the same processing or different parts of the software. In this case, the computers may communicate with each other via the network interface 104 or the like to execute the processing in a distributed computing manner. That is, each device (the client terminal 12 and the server device 14) in the above-described embodiments may be configured as a system that implements functions by one or more computers executing instructions stored in one or more storage devices. Moreover, information transmitted from the terminal may be processed by one or more computers provided in the cloud, and the processing results may be transmitted to the terminal.

Various operations of each device (the client terminal 12 and the server device 14) in the above-described embodiments may be executed in parallel by using one or more processors or by using a plurality of computers via a network. Moreover, the various operations may be distributed to a plurality of processing cores of the processor and executed in parallel. Furthermore, a part or all of the processing, means, and the like of the present disclosure may be implemented by at least one of a processor and a storage device provided in the cloud that is communicable with the computer 7 via a network. As described above, each device in the above-described embodiments may be implemented using parallel computing by one or more computers.

The processor 101 may be an electronic circuit (e.g., a processing circuit, processing circuitry, a CPU, a GPU, an FPGA, and an ASIC) that performs at least one of control and computation of a computer. The processor 101 may be a general-purpose processor, a dedicated processing circuit designed to execute a specific operation, or a semiconductor device including both a general-purpose processor and a dedicated processing circuit. The processor 101 may include an optical circuit, or may include a computation capability based on quantum computing.

The processor 101 may perform computation based on software or data input from devices of the internal configuration of the computer 7, and may output computation results or control signals to the devices. The processor 101 may control each component constituting the computer 7 by executing an operating system (OS), applications, and the like of the computer 7.

Each device (the client terminal 12 and the server device 14) in the above-described embodiments may be implemented by one or more processors 101. Herein, the processor 101 may refer to one or more electronic circuits arranged on one chip, or may refer to one or more electronic circuits arranged on two or more chips or on two or more devices. In a case of using a plurality of electronic circuits, the electronic circuits may communicate with each other via wired or wireless communication.

The main storage device 102 may store instructions to be executed by the processor 101, various types of data, and the like, and information stored in the main storage device 102 may be read by the processor 101. The auxiliary storage device 103 is a storage device other than the main storage device 102. Note that these storage devices refer to any electronic components capable of storing information, and may be semiconductor memories. The semiconductor memory may be a volatile memory or a nonvolatile memory. A storage device configured to store various data and the like in each device (the client terminal 12 and the server device 14) in the above-described embodiments may be implemented by the main storage device 102 or the auxiliary storage device 103, or may be implemented by a memory integrated in the processor 101.

In a case where each device (the client terminal 12 and the server device 14) in the above-described embodiments includes at least one storage device (memory) and at least one processor connected (coupled) to the at least one storage device, the at least one processor may be connected to one storage device. Moreover, the at least one storage device may be connected to one processor. At least one processor among a plurality of processors may be connected to at least one storage device among a plurality of storage devices. This configuration may be realized by storage devices and processors included in a plurality of computers. The storage device may be integrated with the processor (e.g., a cache memory including an L1 cache and an L2 cache).

The network interface 104 is an interface for connecting to a communication network 8 via wireless or wired communication. The network interface 104 is an appropriate interface such as an interface conforming to an existing communication standard. Via the network interface 104, information may be exchanged with an external device 9A that is connected to the communication network 8. The communication network 8 may be any one of a wide area network (WAN), a local area network (LAN), a personal area network (PAN), or the like, or a combination thereof, and may be any network used for exchanging information between the computer 7 and the external device 9A. Examples of a WAN include the Internet. Examples of a LAN include IEEE 802.11 and Ethernet (trademark). Examples of a PAN include Bluetooth (trademark) and near field communication (NFC).

The device interface 105 is an interface such as a USB that directly connects to the external device 9B.

The external device 9A is a device connected to the computer 7 via the communication network 8. The external device 9B is a device directly connected to the computer 7.

The external device 9A or the external device 9B may be, for example, an input device. The input device is, for example, a camera, a microphone, a motion capture device, various sensors, a keyboard, a mouse, a touch panel, or the like and provides the acquired information to the computer 7. The input device may be a personal computer, a tablet terminal, a smartphone, or the like, which includes an input unit, a memory, and a processor.

The external device 9A or the external device B may be, for example, an output unit. The output device may be, for example, a display device such as a liquid crystal display (LCD) or an organic electroluminescence (EL) panel, or may be a speaker or the like that outputs sound or the like. The output device may be a personal computer, a tablet terminal, a smartphone, or the like, which includes an output unit, a memory, and a processor.

The external device 9A or the external device 9B may be, for example, a storage device (memory). For example, the external device 9A may be a network storage or the like, and the external device 9B may be a storage such as a hard disk drive (HDD).

The external device 9A or the external device 9B may be a device having part of the functions of the components of each device (the client terminal 12 and the server device 14) in the above-described embodiments. That is, the computer 7 may transmit a part or all of the processing results to the external device 9A or the external device 9B, or may receive a part or all of the processing results from the external device 9A or the external device 9B.

In this specification (including the claims), when the expression “at least one of a, b, and c” or “at least one of a, b, or c” (including similar expressions) is used, the expression encompasses one of a, b, or c individually, a combination of a and b, a combination of a and c, a combination of b and c, or a combination of a, b, and c. The expression may also encompass multiple instances of any element, such as a combination of a and a, or a combination of a, a, b, b, c, and c. The expression further encompasses inclusion of an additional element other than the listed elements (a, b, and c), such as a combination of a, b, c, and d, where d is added.

In this specification (including the claims), when expressions such as “using data as input,” “using data,” “based on data,” “according to data,” or “in accordance with data” (including similar expressions) are used, unless otherwise specified, such expressions encompass a case where the data itself is used, as well as a case where data subjected to processing is used, such as data with added noise, normalized data, features extracted from data, intermediate representations of data, or the like. When it is described that some result is obtained “using data as input,” “using data,” “based on data,” “according to data,” or “in accordance with data” (including similar expressions), unless otherwise specified, such description encompasses a case where the result is obtained based solely on the data, as well as a case where the result is obtained while being influenced by data, factors, conditions, and/or states other than the data. When it is described that “data is output” (including similar expressions), unless otherwise specified, such description encompasses a case where the data itself is used as the output, as well as a case where data subjected to processing is used as the output, such as data with added noise, normalized data, features extracted from data, intermediate representations of data, or the like.

In this specification (including the claims), when the terms “connected” and “coupled” are used, such terms are intended to be non-limiting terms that encompass direct connection or coupling, indirect connection or coupling, electrical connection or coupling, communicative connection or coupling, operative connection or coupling, physical connection or coupling, and the like. The terms should be interpreted as appropriate in light of the context in which the terms are used. However, any connection or coupling forms that are not intentionally or inherently excluded should be interpreted as being included within the scope of the terms in a non-limiting manner.

In this specification (including the claims), when the expression “A configured to B” is used, such expression may encompass a case where a physical structure of element A has a configuration capable of performing operation B, and a permanent or temporary setting or configuration of element A is set so as to actually perform operation B. For example, in a case where element A is a general-purpose processor, the processor may have a hardware configuration capable of executing operation B, and may be configured to actually execute operation B by execution of a permanent or temporary program (instructions). When element A is a dedicated processor, a dedicated processing circuit, or the like, the circuit structure of the processor may be implemented to actually perform operation B, regardless of whether control instructions and data are actually provided.

In this specification (including the claims), when a term indicating inclusion or possession (e.g., “comprising,” “including,” and “having”) is used, such term is intended to be open-ended and to encompass inclusion or possession of additional elements other than those explicitly recited. When the object of any of the terms indicating inclusion or possession does not specify a quantity or is expressed using the article “a” or “an,” such expression should be construed as not being limited to a specific number.

In this specification (including the claims), even if expressions such as “one or more” or “at least one” are used in certain portions, and expressions that do not specify a quantity or that use the articles “a” or “an” are used in other portions, the latter expressions are not intended to mean “one.” In general, expressions that do not specify a quantity or that use the articles “a” or “an” are interpreted as not necessarily limited to a specific number.

In this specification, when it is described that a specific advantage or result is obtained by a specific configuration of an embodiment, it should be understood that the same advantage or result is also obtained by one or more other embodiments having the same configuration, unless otherwise stated. However, it should be understood that the effect may or may not be obtained depending on various factors, conditions, and/or states, and is not necessarily obtained solely by the configuration. The effect is merely obtained by the configuration described in the embodiment when various factors, conditions, and/or states are satisfied, and is not necessarily obtained in an invention as defined by a claim reciting the configuration or a similar configuration.

In this specification (including the claims), when a term such as “maximize” or “maximization” is used, the term encompasses obtaining a global maximum, obtaining an approximation of a global maximum, obtaining a local maximum, and obtaining an approximation of a local maximum, and should be interpreted accordingly depending on the context in which the term is used. Such a term also encompasses obtaining approximations of these maxima stochastically or heuristically. Similarly, when a term such as “minimize” or “minimization” is used, the term encompasses obtaining a global minimum, obtaining an approximation of a global minimum, obtaining a local minimum, and obtaining an approximation of a local minimum, and should be interpreted accordingly depending on the context in which the term is used. Such a term also encompasses obtaining approximations of these minima stochastically or heuristically. Similarly, in this specification (including the claims), when a term such as “optimize” or “optimization” is used, the term encompasses obtaining a global optimum, obtaining an approximation of a global optimum, obtaining a local optimum, and obtaining an approximation of a local optimum, and should be interpreted accordingly depending on the context in which the term is used. Such a term also encompasses obtaining approximations of these optima stochastically or heuristically.

In this specification (including the claims), when a plurality of hardware components perform predetermined processing, the hardware components may cooperate to perform the processing, or one or more of the hardware components may perform all of the processing. Further, some of the hardware components may perform a portion of the predetermined processing, and other hardware components may perform the remaining portion of the predetermined processing. In this specification (including the claims), when an expression such as “one or more hardware components perform first processing, and the one or more hardware components perform second processing” (including similar expressions) is used, the hardware components performing the first processing and the hardware components performing the second processing may be the same or different. That is, the hardware components performing the first processing and the hardware components performing the second processing may be included among the one or more hardware components. The hardware components may include an electronic circuit, a device including an electronic circuit, and/or the like.

In this specification (including the claims), when a plurality of storage devices (memories) store data, each of the storage devices may store a portion of the data or may store the entirety of the data. Moreover, some of the plurality of storage devices may store data.

In this specification (including the claims), terms such as “first” and “second” are used merely to distinguish between two or more elements, and are not necessarily intended to impose any technical meaning, such as a temporal aspect, a spatial aspect, an order, or a quantity, on the subject. Thus, for example, a reference to first and second elements does not necessarily mean that only two elements may be employed, that the first element must precede the second element, or that the first element must be present for the second element to be present.

Although the embodiments of the present disclosure have been described in detail above, the present disclosure is not limited to the individual embodiments described above. Various additions, modifications, replacements, and partial deletions may be made without departing from the spirit and scope of the present invention as derived from the claims and equivalents thereof. For example, in the above-described embodiments, numerical values or mathematical expressions used to describe the embodiments are provided for illustrative purposes only and are not intended to limit the scope of the present disclosure. The order of the operations described in the embodiments is provided for illustrative purposes only and does not limit the scope of the present disclosure.

### Supplement

<1> An information processing device, including:
   at least one memory; and
   at least one processor configured to:
      generate a first prompt;
      acquire a first output result generated by a model in response to an input of the first prompt;
      acquire first feedback information for the first output result;
      generate a second prompt by using information acquired through execution of a predetermined algorithm based on the first feedback information; and
      acquire a second output result generated by the model in response to an input of the second prompt.
<2> The information processing device according to <1>, in which
   the information acquired through the execution of the predetermined algorithm includes one or more items selected from a plurality of items.
<3> The information processing device according to <2>, in which
   the at least one processor is further configured to execute the predetermined algorithm based on a history of information on one or more items selected in past and information on an evaluation value acquired in the past.
<4> The information processing device according to <3>, in which
   the at least one processor is further configured to select the history used for the predetermined algorithm.
<5> The information processing device according to <4>, in which
   the at least one processor is further configured to select the history based on an instruction from a user or an output from the model.
<6> The information processing device according to <4>, in which
   the at least one processor is further configured to update the evaluation value in the history used for the predetermined algorithm.
<7> The information processing device according to <2>, in which
   the at least one processor is further configured to execute the predetermined algorithm by using vector representations of one or more items in text.
<8> The information processing device according to <7>, in which
   the at least one processor is further configured to execute the predetermined algorithm by using similarity of the vector representations of the items in the text.
<9> The information processing device according to <1>, in which
   the at least one processor is further configured to generate the second output result by inputting the second prompt into the model.
<10> The information processing device according to any one of <1> to <9>, in which
   the predetermined algorithm is an optimization algorithm.
<11> The information processing device according to any one of <1> to <9>, in which
   the first feedback information includes information indicating an evaluation value and information in natural language acquired from a user.
<12> The information processing device according to <11>, in which
   the second prompt includes the information in the natural language acquired from the user.
<13> The information processing device according to any one of <1> to <9>, in which
   the second prompt includes information on part of the first output result.
<14> The information processing device according to any one of <1> to <9>, in which
   the at least one processor is further configured to repeat a process of acquiring second feedback information for the second output result, generating the second prompt by using information acquired through execution of the predetermined algorithm based on the second feedback information, and acquiring the second output result generated by the model in response to an input of the second prompt until a predetermined criterion is satisfied.
<15> The information processing device according to <14>, in which
   the second prompt includes a plurality of pieces of information in natural language acquired from a plurality of pieces of the second feedback information.
<16> The information processing device according to any one of <1> to <9>, in which
   the second prompt includes the acquired information and information specifying an output format of the second output result.
<17> The information processing device according to <16>, in which
   the second prompt specifies a markup language as the output format of the second output result.
<18> The information processing device according to any one of <1> to <9>, in which
   the first feedback information includes evaluation information for the first output result.
<19> The information processing device according to <18>, in which
   the evaluation information for the first output result is specified by a user manipulating a radio button or a slider.
<20> The information processing device according to any one of <1> to <9>, in which
   the at least one processor is further configured to generate the first feedback information by analyzing the first output result.
<21> The information processing device according to any one of <1> to <9>, in which
   the at least one processor is further configured to:
      generate a plurality of first prompts;
      acquire a plurality of first output results generated by the model in response to an input of the plurality of first prompts; and
      acquire the first feedback information by a user for the first output result selected by the user from the plurality of first output results.
<22> An information processing method, comprising:
   generating, by at least one processor, a first prompt;
   acquiring, by the at least one processor, a first output result generated by a model in response to an input of the first prompt;
   acquiring, by the at least one processor, first feedback information for the first output result;
   generating, by the at least one processor, a second prompt by using information acquired through execution of a predetermined algorithm based on the first feedback information; and
   acquiring, by the at least one processor, a second output result generated by the model in response to an input of the second prompt.
<23> A non-transitory computer-readable storage medium storing a program, which when executed, causes at least one computer to execute procedures of:
   generating a first prompt;
   acquiring a first output result generated by a model in response to an input of the first prompt;
   acquiring first feedback information for the first output result;
   generating a second prompt by using information acquired through execution of a predetermined algorithm based on the first feedback information; and
   acquiring a second output result generated by the model in response to an input of the second prompt.

The “second prompt” in <13> may be different from the “second prompt” in <1>, but is referred to as the “second prompt” for convenience of expression. For example, the “second prompt” in <13> may be a “third prompt” or a subsequent prompt that is generated after the “second prompt” in <1>.

Similarly, the “second output result” in <13> may be the “second output result” in <1>, or may be an output result generated by a language model in response to an input of the “third prompt” or the subsequent prompt, which is generated after the “second prompt.”

Similarly, the “second feedback information” in <13> may be “third feedback information” or subsequent feedback information repeatedly acquired after the “first feedback information” in <1>.

Although the present invention has been described based on the embodiments, the present invention is not limited to the above-described embodiments, and various modifications can be made within the scope of the claims.

What is claimed is:

1. An information processing device, comprising:
at least one memory; and
at least one processor configured to:
generate a first prompt;
acquire a first output result generated by a model in response to an input of the first prompt;
acquire first feedback information for the first output result;
generate a second prompt by using information acquired through execution of a predetermined algorithm based on the first feedback information; and
acquire a second output result generated by the model in response to an input of the second prompt.

2. The information processing device according to claim 1, wherein
the information acquired through the execution of the predetermined algorithm includes one or more items selected from a plurality of items.

3. The information processing device according to claim 2, wherein
the at least one processor is further configured to execute the predetermined algorithm based on a history of information on one or more items selected in past and information on an evaluation value acquired in the past.

4. The information processing device according to claim 3, wherein
the at least one processor is further configured to select the history used for the predetermined algorithm.

5. The information processing device according to claim 4, wherein
the at least one processor is further configured to select the history based on an instruction from a user or an output from the model.

6. The information processing device according to claim 2, wherein
the at least one processor is further configured to execute the predetermined algorithm by using similarity of vector representations of one or more items in text.

7. The information processing device according to claim 1, wherein
the at least one processor is further configured to generate the second output result by inputting the second prompt into the model.

8. The information processing device according to claim 1, wherein
the predetermined algorithm is an optimization algorithm.

9. The information processing device according to claim 1, wherein
the first feedback information includes information indicating an evaluation value and information in natural language acquired from a user.

10. The information processing device according to claim 11, wherein
the second prompt includes the information in the natural language acquired from the user.

11. The information processing device according to claim 1, wherein
the second prompt includes information on part of the first output result.

12. The information processing device according to claim 1, wherein
the at least one processor is further configured to repeat a process of acquiring second feedback information for the second output result, generating the second prompt by using information acquired through execution of the predetermined algorithm based on the second feedback information, and acquiring the second output result generated by the model in response to an input of the second prompt until a predetermined criterion is satisfied.

13. The information processing device according to claim 1, wherein
the second prompt includes the acquired information and information specifying an output format of the second output result.

14. The information processing device according to claim 16, wherein
the second prompt specifies a markup language as the output format of the second output result.

15. The information processing device according to claim 1, wherein
the first feedback information includes evaluation information for the first output result.

16. The information processing device according to claim 18, wherein
the evaluation information for the first output result is specified by a user manipulating a radio button or a slider.

17. The information processing device according to claim 1, wherein
the at least one processor is further configured to generate the first feedback information by analyzing the first output result.

18. The information processing device according to claim 1, wherein
the at least one processor is further configured to:
generate a plurality of first prompts;
acquire a plurality of first output results generated by the model in response to an input of the plurality of first prompts; and
acquire the first feedback information by a user for the first output result selected by the user from the plurality of first output results.

19. An information processing method, comprising:
generating, by at least one processor, a first prompt;
acquiring, by the at least one processor, a first output result generated by a model in response to an input of the first prompt;
acquiring, by the at least one processor, first feedback information for the first output result;
generating, by the at least one processor, a second prompt by using information acquired through execution of a predetermined algorithm based on the first feedback information; and
acquiring, by the at least one processor, a second output result generated by the model in response to an input of the second prompt.

20. A non-transitory computer-readable storage medium storing a program, which when executed, causes at least one computer to execute procedures of:
generating a first prompt;
acquiring a first output result generated by a model in response to an input of the first prompt;
acquiring first feedback information for the first output result;
generating a second prompt by using information acquired through execution of a predetermined algorithm based on the first feedback information; and
acquiring a second output result generated by the model in response to an input of the second prompt.
